(19) United States
(12) Patent Application Publication
(10) Pub. No.: US 2007/0220885 A1
(43) Pub. Date: Sep. 27, 2007

(54) EGR energy recovery system

(76) Inventors: David Turner, Bloomfield Hills, MI (US); James Oliver, Orion, MI (US); Santosh K. Viswandham, Kalamazoo, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/386,278

(22) Filed: Mar. 22, 2006

(51) Int. Cl. F02B 33/00; F02B 33/44

(52) U.S. Cl. 60/605.2; 60/612; 123/565

(57) ABSTRACT

An exhaust gas recirculation (EGR) system for an engine in which a portion of the exhaust gas is recirculated from an exhaust port of the engine into an intake port of the engine. The EGR system includes an exhaust gas recirculation line connecting said exhaust port of said engine to said intake port of said engine; a turbine disposed along the recirculation line; and a motor generator in operative communication with the turbine. The pressure and flow of a portion of said exhaust gas produced by said engine and recirculated from said exhaust port to said intake port is used to operate the turbine and the motor generator derives electric power from the operation of the turbine. In an embodiment, the motor generator can be used to drive the turbine to manipulate EGR flow. A method for recovering energy in connection with an EGR system is also disclosed.

### BACKGROUND

1. Technical Field

The present invention relates to an exhaust gas recirculation (EGR) system for internal combustion engines.

2. Background

Increasing demands are commonly placed on engine and vehicle manufacturers to provide engines that provide improved performance, reliability, and durability while at the same time reducing undesirable emissions. Diesel engines, particularly those used for heavy duty, often employ extensive amounts of EGR.

Moreover, with turbocharged engines that include EGR, EGR is typically performed by allowing some portion of the exhaust gas in the exhaust passage to flow toward an intake passage through an EGR flow path. The recirculation of exhaust gas by-products into an intake air supply of an internal combustion engine, which can then be reintroduced into an engine cylinder, can reduce the concentration of oxygen therein which, in turn, can lower the maximum combustion temperature within the cylinder and slow the chemical reaction of the combustion process, thereby decreasing the formation of nitrous oxides (NOx).

However, because exhaust gas is at an elevated temperature and must typically be cooled before returning to the air inlet system, additional and substantial cooling systems are commonly employed for that purpose. Generally, such systems involve the inclusion of an additional (and commonly enlarged) radiator/heat exchanger. However, the inclusion of such additional equipment can, among other things, raise packaging design issues and necessitate the removal of an increased amount of heat from the system.

Further, in the past, such exhausted energy was not always considered worth recovering. However, today, with the increasing use of EGR and the expanding potential uses for recovered energy, for example, in connection with hybrid technologies, there is an interest in both removing more and more heat or energy from EGR systems and recovering it for beneficial purposes.

### SUMMARY

An exhaust gas recirculation (EGR) system for an internal combustion engine in which a portion of the exhaust gas produced by the engine is recirculated from an exhaust port of the engine into an intake port of the engine. The EGR system includes an exhaust gas recirculation line connecting said exhaust port of said engine to said intake port of said engine; a turbine disposed along the exhaust gas recirculation line; and a motor generator in operative communication with the turbine. The pressure and flow of a portion of said exhaust gas produced by said engine and recirculated from said exhaust port to said intake port is used to operate the turbine and the motor generator derives electric power from the operation of the turbine. In an embodiment, the motor generator can be used to drive the turbine to manipulate EGR flow. A method for recovering energy in connection with an EGR system for an internal combustion engine is also disclosed.

### BRIEF DESCRIPTION OF THE DRAWINGS

Embodiments of the invention will now be described, by way of example, with reference to the accompanying drawings, wherein:

FIG. 1 is a schematic illustration of an EGR system according to an embodiment of the present invention; and

FIG. 2 is a schematic illustration of an EGR system according to another embodiment of the present invention.

### DETAILED DESCRIPTION

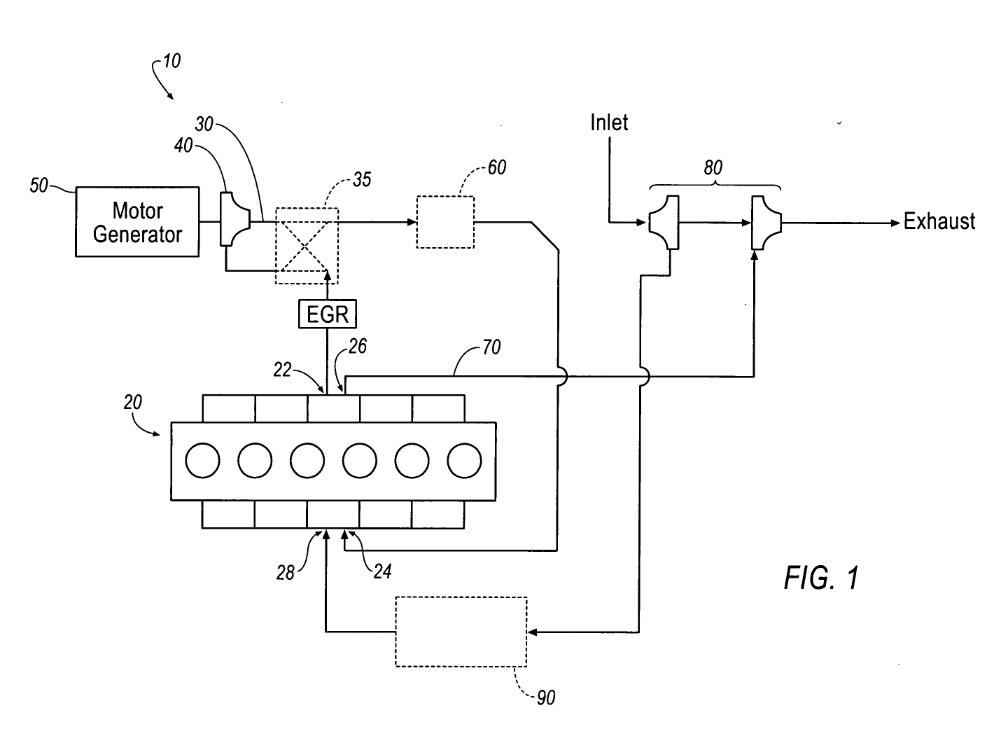

Referring to FIG. 1, an exhaust gas recirculation (EGR) system 10 according to an embodiment of the present invention is shown. In the illustrated embodiment, the EGR system 10 is connected to an internal combustion engine 20 having an exhaust port 22 and an intake port 24. However, the engine 10 need not be limited to a single exhaust port and a single intake port and may include a plurality of exhaust ports and/or intake ports. For example, and without limitation, the illustrated engine includes a second exhaust port 26 and a second intake port 28.

As shown in FIG. 1, system 10 is connected to engine 20, the system 10 including an exhaust gas recirculation line 30; a turbine 40; and a motor generator 50. If desired, the system 10 may optionally include a cooler 60.

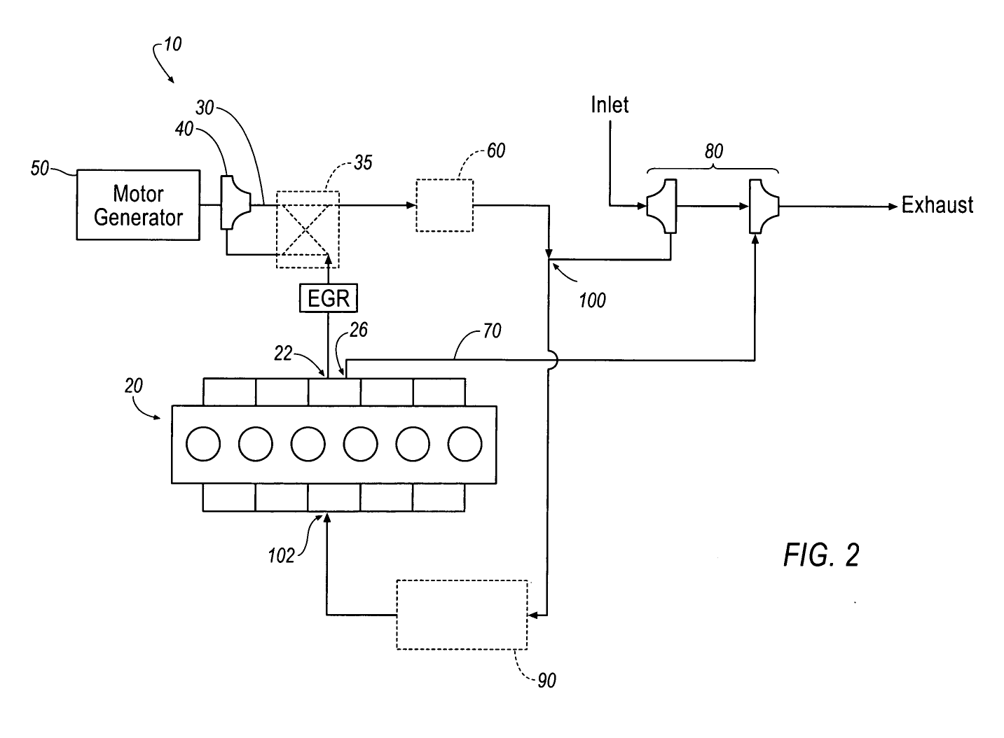

The system 10 may further include a control device for controlling the amount of exhaust gas that is permitted to flow from the engine 20 into the exhaust gas recirculation line 30. The control device may include, for example, a conventional valve or other flow-control device suitable for the functional environment. For example, as illustrated in FIGS. 1 and 2 in phantom line format, a control valve 35 may be optionally included. The control valve 35 may be disposed along the recirculation line 30 between the exhaust port of the engine and the turbine. The control valve 35 is shown receiving exhaust flow from the engine. With such a control valve, exhaust from the engine exhaust port can be directed to turbine 40 or, if desired, could instead be routed past the turbine and on along the recirculation path. The control valve may include, for example, any number of conventional valves including, without limitation, a four-way valve that could either be of the poppet, butterfly, or other type. Moreover, exhaust that has been directed to (and through) turbine 40 can, for example as illustrated, be directed back through a control valve 35, or could instead bypass the valve and be directed onward along the illustrated recirculation line. Further, the control valve 35 can, if desired, be configured to help prevent undesirable contaminants from flowing through the system.

The exhaust gas recirculation line 30 serves to provide a fluid connection from exhaust port 22 to intake port 24 of engine 20. However, as used herein, the term recirculation line is to be interpreted broadly and is not limited to a single contiguous line, and, if desired, may be comprised of individual line segments that form a substantially continuous flow path. As generally illustrated, turbine 40 is disposed along the exhaust gas recirculation line 30, and motor generator 50 is in operative communication with the turbine 40.

In an embodiment, the pressure and flow associated with the portion of exhaust gas flowing from engine exhaust port 22 is used, at least in part, to operate the turbine 40. For example, without limitation, at mid throttle, from about 30% to about 40% of the exhaust may be directed for EGR flow associated with the exhaust gas recirculation line 30. Moreover, as used herein, the term “turbine” is meant to include mechanisms for translating the flow of exhaust gas into kinetic energy, for example, by rotating a plurality of blades associated with the turbine.

A motor generator 50 may be in operative communication with the turbine, whereby energy, such as the kinetic energy associated with the operation of the turbine, can be transformed into electrical energy by the motor generator 50. Conversely, if desired, the motor generator 50 may supply power to the turbine that can be used to force gas through or along the exhaust gas recirculation line 30. The motor generator 50 may be, for example and without limitation, a conventional motor generator that is suitable for deriving electrical power from the operation of the turbine 40 and, if desired, also provide power to operate the turbine 40 (for example, in a “pump” mode).

The flow of the exhaust gas through or past turbine 40 will typically reduce or lower the temperature associated with the exhaust gas flowing thereby or therethrough. However, as previously noted, if desired a cooler 60, may be directly integrated into the flow path, selectably activated, or, if an optional route by-pass (not shown) is included, selectably introduced into the system 10 and the flow of the exhaust gas. The cooler 60 can serve to further reduce the temperature of the exhaust gas prior to their reentry into the intake of the engine 20.

As generally illustrated in the embodiment shown in FIG. 1, the EGR system 10 may further include a second exhaust gas recirculation line 70. The second exhaust gas recirculation line 70 may serve to provide a fluid connection from second exhaust port 26 to a second intake port 28 of engine 20. Although the exhaust port 22 and second exhaust port 26 are depicted as separate ports in connection with engine, those of skill in the art will recognize that the ports may take the form of a single port and after exiting the engine the associated lines may divert into the exhaust gas recirculation line 30 and the second exhaust gas recirculation line 70, and further that the amount of flow to either line may be selectably controlled, such as by a valve or other flow device.

In the embodiment illustrated, a turbo-charging device 80 is shown disposed along a portion of the path of the second exhaust gas recirculation line 70. The “inlet” and “exhaust” of ambient or atmospheric gas(es) associated with the turbo-charging device are generally noted in the figure. It should be noted that the present invention is not limited to any specific type of turbo-charging device and the turbo-charging device may comprise a wide array of conventional turbochargers or similar devices used to serve similar purposes.

With continued reference to FIG. 1, and the flow path illustrated in connection with second gas recirculation line 70, the system 10 may optionally further include an after-cooler 90. The after-cooler 90 may be disposed along the second gas recirculation line 70 following the turbo-charging device 80, i.e., between the turbo-charging device 80 and second intake port 28. In a similar fashion to the cooler 60, previously discussed, after-cooler 90, may be directly integrated into the flow path, selectably activated, or, if an optional route by-pass (not shown) is included, selectably introduced into the system 10 and the flow of the exhaust gas. The cooler 60 can serve to further reduce the temperature of the exhaust gas prior to their reentry into the intake of the engine 20.

As previously noted, the operation of the turbine associated with the flow of exhaust gas by or through turbine 40 can be transformed into electrical energy by the motor generator. That energy may thereafter be provided to, for example, one or more batteries to be stored or, instead, may be used or routed to directly, or indirectly, power or provide supplemental power to various components or systems associated with a vehicle.

Moreover, during periods when there is less than the desired amount of flow of exhaust gas through or within the exhaust gas recirculation line 30, the motor generator 50 can be used to supply power to the turbine that can be used to manipulate the exhaust flow in the system, for example, by forcing an increased flow or amount of exhaust gas through or along the exhaust gas recirculation line 30. One of skill in the art will readily recognize that the EGR system associated with the present invention may include a controller (not shown) that is in communication with the motor generator 50 that can, if desired, monitor the flow of exhaust gas associated with the system at one or more positions along the flow path and control the operation of the turbine and/or the motor generator as desired. For example, without limitation, the controller may be programmed to meter or control the flow exhaust gas through the exhaust gas recirculation line according to select or specified engine requirements.

Turning to FIG. 2, another embodiment of an EGR system 10a is shown. Many of the elements associated with FIG. 2 have been previously illustrated and discussed in connection with FIG. 1 and, for ease of reference, the numbering scheme has generally been maintained.

The embodiment of the invention shown in FIG. 2 is similar to that illustrated in FIG. 1. However, as readily seen, system includes an intake line 100, and flow of gas(es) introduced from the second exhaust gas recirculation line 70 now join the flow of exhaust gas (“return”) flow from the exhaust gas recirculation line 30. As shown, the intake line 100, which may be part of the second exhaust gas recirculation line 70, or may simply be a component or branch thereof, is in fluid communication with the exhaust gas recirculation line. The intake line 100 may connect to or may otherwise be disposed along a portion of the exhaust gas recirculation line 30 following the motor generator 50, i.e., between the motor generator 50 and one or more engine intake ports, for example, common engine intake port 102. If an after-cooler 90 is included in the system 10, the intake line 100 may connect to or may otherwise be disposed along a portion of the exhaust gas recirculation line 30 before the after-cooler 90, i.e., between the motor generator 50 and the after-cooler 90.

Consequently, an embodiment of the EGR system of the present invention can, if desired, serve to (a) recover energy (in the form of electricity) from energy associated with exhaust gas that would ordinarily need to be removed from the system, which may involve special or larger components and additional handling; and/or (b) the same components or hardware associated with the system can function or serve as an EGR pump.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. An exhaust gas recirculation system for an internal combustion engine in which a portion of the exhaust gas produced by the engine is recirculated from an exhaust port of the engine into an intake port of the engine, the exhaust gas recirculation system comprising:
an exhaust gas recirculation line connecting said exhaust port of said engine to said intake port of said engine;
a turbine disposed along the exhaust gas recirculation line; and
a motor generator in operative communication with the turbine;
wherein the pressure and flow of said portion of said exhaust gas produced by said engine and recirculated from said exhaust port to said intake port is used to operate the turbine and the motor generator derives electric power from the operation of the turbine.

2. The system according to claim 1, including a cooler for reducing the temperature associated with said exhaust gas recirculated from said exhaust port to said intake port, the cooler disposed along the exhaust gas recirculation line between the turbine and said intake port of said engine.

3. The system according to claim 1, including a control device for controlling the amount of said exhaust gas permitted to flow from the engine into the exhaust gas recirculation line.

4. The system according to claim 3, wherein the control device includes a control valve disposed along the exhaust gas recirculation line between the exhaust port and the turbine.

5. The system according to claim 1, said engine include a second exhaust port and a second intake port.

6. The system according to claim 5, wherein the system includes a second exhaust gas recirculation line connecting said second exhaust port of said engine to said second intake port of said engine.

7. The system according to claim 6, wherein the said exhaust port and said second exhaust port are the same port, and said exhaust gas is diverted to either the exhaust gas recirculation line or the second exhaust gas recirculation line after leaving the engine.

8. The system according to claim 7, including an after-cooler disposed along a portion of the second exhaust gas recirculation line.

9. The system according to claim 7, wherein a portion of said exhaust gas produced by said engine are circulated from said second exhaust port to said second intake port.

10. The system according to claim 8, including a turbocharger, the turbocharger being disposed along the second exhaust gas recirculation line.

11. The system according to claim 10, including an after-cooler disposed along a portion of the second exhaust gas recirculation line between the turbocharger and said second intake port.

12. The system according to claim 1, wherein during periods when there is less than a desired flow of exhaust gas through or within the exhaust gas recirculation line, the motor generator can be used to force gas to flow to said intake port of said engine.

13. The system according to claim 12, including a controller in communication with the motor generator, wherein the controller monitors the flow of exhaust gas and controls the operation of the turbine.

14. The system according to claim 13, wherein the controller is programmed to meter or control the flow of exhaust gas through the exhaust gas recirculation line according to engine requirements.

15. The system according to claim 1, wherein the electrical power created by the system is directed to a battery or an electrical system for storage or use.

16. An exhaust gas recirculation system for an internal combustion engine in which a portion of the exhaust gas produced by the engine is recirculated from an exhaust port of the engine into an intake port of the engine, the exhaust gas recirculation system comprising:
an exhaust gas recirculation line connecting said exhaust port of said engine to said intake port of said engine;
a turbine disposed along the exhaust gas recirculation line;
a motor generator in operative communication with the turbine; and
an intake line for directing additional gas into the exhaust gas recirculation line, the intake line in fluid communication with the exhaust gas recirculation line along a portion of the exhaust gas recirculation line between the turbine and said engine intake port;
whereby the pressure and flow of said portion of said exhaust gas produced by said engine and recirculated from said exhaust port to said intake port is used to operate the turbine and the motor generator derives electric power from the operation of the turbine.

17. The system according to claim 16, including a cooler for reducing the temperature associated with said exhaust gas recirculated from said exhaust port to said intake port, the cooler being disposed along the exhaust gas recirculation line between the turbine and said intake port of said engine.

18. The system according to claim 17, wherein the cooler is disposed along the exhaust gas recirculation line between the turbine and the intake line.

19. The system according to claim 16, including an after-cooler disposed along the exhaust gas recirculation line between the intake line and said intake port.

20. The system according to claim 16, including a cooler disposed along the exhaust gas recirculation line between the turbine and the intake line, and an after-cooler disposed along the exhaust gas recirculation line between the intake line and said intake port.

21. The system according to claim 16, wherein during periods when there is less than a desired flow of exhaust gas through or within the exhaust gas recirculation line, the motor generator can be used to force gas to flow to said intake port of said engine.

22. A method for recovering energy in connection with an exhaust gas recirculation system for an internal combustion engine, the method comprising:
circulating of a portion of the exhaust gas produced by said engine from an exhaust port of the engine through an exhaust gas recirculation line by or through a turbine prior to reentry of the gas into said engine; and
generating electric power derived from the flow of the exhaust by or through the turbine.

23. The method according to claim 22, wherein, when the circulation of exhaust gas within or through the exhaust gas recirculation line is less than desired, the method includes operating the turbine to force the flow of exhaust gas.
